(19) United States
(12) Patent Application Publication
(10) Pub. No.: US 2025/0232745 A1
(43) Pub. Date: Jul. 17, 2025

(54) DISPLAY APPARATUS, TIMING CONTROLLER AND CONTROL METHOD THEREOF

(71) Applicants: Chengdu BOE Optoelectronics Technology Co., Ltd., Chengdu, Sichuan (CN); BOE Technology Group Co., Ltd., Beijing (CN)

(72) Inventor: Xiaoxu LI, Beijing (CN)

(21) Appl. No.: 18/685,011

(22) PCT Filed: May 16, 2023
(86) PCT No.: PCT/CN2023/094486

§ 371 Date: Feb. 20, 2024

(51) Int. Cl. G09G 5/10; G09G 5/00

(52) U.S. Cl. CPC G09G 5/10; G09G 5/003; G09G 2310/061; G09G 2310/08; G09G 2320/0233; G09G 2320/0247; G09G 2320/0626

(57) ABSTRACT

The present disclosure provides a display apparatus, a timing controller and a control method thereof. The control method of the timing controller includes: receiving and storing a video stream, where the video stream includes n initial display frames arranged in sequence, n is greater than or equal to 2, and a frame frequency of each initial display frame sequentially increases or decreases from a first initial display frame to an n-th initial display frame; generating a luminance control signal and n modified display frames according to the n initial display frames, where the n modified display frames respectively correspond to the n initial display frames; the luminance control signal is a pulse signal and includes n control segments, and the n control segments respectively correspond to the n modified display frames; and sending the luminance control signal and the n modified display frames to a display panel, so that the display panel displays according to the modified display frames. The present disclosure can improve display effect.

### TECHNICAL FIELD

The present disclosure relates to the technical field of display, and in particular, to a display apparatus, a timing controller and a control method thereof.

### BACKGROUND

With development of technologies, display apparatuses are drawing more and more attentions. However, existing display apparatuses still need to be improved.

### SUMMARY

A purpose of the present disclosure is to provide a display apparatus, a timing controller and a control method thereof, which can improve display effect.

According to an aspect of the present disclosure, a control method of a timing controller is provided, where the method includes:
receiving and storing a video stream, where the video stream includes n initial display frames arranged in sequence, n is greater than or equal to 2, and a frame frequency of each initial display frame sequentially increases or decreases from a first initial display frame to an n-th initial display frame;
generating a luminance control signal and n modified display frames according to the n initial display frames, where the n modified display frames respectively correspond to the n initial display frames; the luminance control signal is a pulse signal and includes n control segments, and the n control segments respectively correspond to the n modified display frames; and
sending the luminance control signal and the n modified display frames to a display panel, so that the display panel displays according to the modified display frames.

Optionally, duty ratios of the n control segments are same.

Optionally, a number of pulses in each of the n control segments is an integer.

Optionally, two of the n control segments have a same number of pulses.

Optionally, (n−1) control segments respectively corresponding to a second modified display frame to an n-th modified display frame have a same number of pulses.

Optionally, control segments respectively corresponding to a first modified display frame and a second modified display frame have different numbers of pulses.

Optionally, the frame frequency of each initial display frame sequentially decreases, and a number of pulses in a control segment corresponding to the first modified display frame is less than a number of pulses in a control segment corresponding to the second modified display frame; or
the frame frequency of each initial display frame sequentially increases, and a number of pulses in a control segment corresponding to the first modified display frame is greater than a number of pulses in a control segment corresponding to the second modified display frame.

Optionally, each initial display frame includes an emission period and a blanking period, and emission periods of the n initial display frames have a same duration.

Optionally, from the first initial display frame to the n-th initial display frame, the frame frequency of each initial display frame sequentially increases, and the blanking period of each initial display frame sequentially decreases; or
from the first initial display frame to the n-th initial display frame, the frame frequency of each initial display frame sequentially decreases, and the blanking period of each initial display frame sequentially increases.

Optionally, from the first initial display frame to the n-th initial display frame, the frame frequency of each initial display frame sequentially decreases, and a number of pulses in a control segment corresponding to an m-th modified display frame is equal to a number of pulses in a control segment corresponding to a first modified display frame, m is greater than or equal to 3; pulses in the control segment corresponding to the m-th modified display frame have an equal width, and the width of each pulse in the control segment corresponding to the m-th modified display frame is greater than a width of each pulse in the control segment corresponding to the first modified display frame, and a difference between the width of each pulse in the control segment corresponding to the m-th modified display frame and the width of each pulse in the control segment corresponding to the first modified display frame is a first difference, and a product of the first difference and the number of pulses in the control segment corresponding to the first modified display frame is equal to a difference between a blanking period of a (m−1)-th initial display frame and a blanking period of the first initial display frame.

Optionally, from the first initial display frame to the n-th initial display frame, the frame frequency of each initial display frame sequentially decreases, and a number of pulses in a control segment corresponding to an m-th modified display frame is equal to a number of pulses in a control segment corresponding to a first modified display frame, m is greater than or equal to 3; in pulses of the control segment corresponding to the m-th modified display frame, a width of a last pulse is greater than a width of any of remaining pulses, and a difference between the width of the last pulse and the width of any one of the remaining pulses is a second difference, and the second difference is equal to a difference between a blanking period of a (m−1)-th initial display frame and a blanking period of the first initial display frame.

According to an aspect of the present disclosure, a timing controller is provided, where the timing controller includes:
a storage medium, configured to receive and store a video stream, where the video stream includes n initial display frames arranged in sequence, n is greater than or equal to 2, and a frame frequency of each initial display frame sequentially increases or decreases from a first initial display frame to an n-th initial display frame;
a generator, configured to generate a luminance control signal and n modified display frames according to the n initial display frames, where the n modified display frames respectively correspond to the n initial display frames; the luminance control signal is a pulse signal and includes n control segments, and the n control segments respectively correspond to the n modified display frames; and
a transmitter, configured to send the luminance control signal and the n modified display frames to a display panel, so that the display panel displays according to the modified display frames.

Optionally, duty ratios of the n control segments are same.

Optionally, a number of pulses in each of the n control segments is an integer.

Optionally, two of the n control segments have a same number of pulses.

Optionally, (n−1) control segments respectively corresponding to a second modified display frame to an n-th modified display frame have a same number of pulses.

Optionally, control segments respectively corresponding to a first modified display frame and a second modified display frame have different numbers of pulses.

Optionally, the frame frequency of each initial display frame sequentially decreases, and a number of pulses in a control segment corresponding to the first modified display frame is less than a number of pulses in a control segment corresponding to the second modified display frame; or
the frame frequency of each initial display frame sequentially increases, and a number of pulses in a control segment corresponding to the first modified display frame is greater than a number of pulses in a control segment corresponding to the second modified display frame.

Optionally, each initial display frame includes an emission period and a blanking period, and emission periods of the n initial display frames have a same duration.

Optionally, from the first initial display frame to the n-th initial display frame, the frame frequency of each initial display frame sequentially increases, and the blanking period of each initial display frame sequentially increases; or
from the first initial display frame to the n-th initial display frame, the frame frequency of each initial display frame sequentially decreases, and the blanking period of each initial display frame sequentially decreases.

According to an aspect of the present disclosure, a display apparatus is provided, including a processor, a display panel, and the timing controller, where the processor is configured to send the video stream to the timing controller, and the display panel is configured to receive the luminance control signal and the n modified display frames sent by the timing controller.

According to the display apparatus, the timing controller and the control method thereof in the present disclosure, a luminance control signal and n modified display frames are generated according to n initial display frames, where the n modified display frames respectively correspond to the n initial display frames, the luminance control signal and the n modified display frames are sent to a display panel, so that the display panel displays according to the modified display frames, thereby improving display effect.

### BRIEF DESCRIPTION OF DRAWINGS

FIG. 1 is a schematic diagram of a video stream and a luminance control signal in related technologies.

FIG. 2 is a schematic diagram of a video stream received by a timing controller according to an embodiment of the present disclosure.

FIG. 3 is a block diagram of a display apparatus according to an embodiment of the present disclosure.

FIG. 4 is a schematic diagram of modified display frames and a luminance control signal according to an embodiment of the present disclosure.

FIG. 5 is another schematic diagram of modified display frames and a luminance control signal according to an embodiment of the present disclosure.

FIG. 6 is another schematic diagram of modified display frames and a luminance control signal according to an embodiment of the present disclosure.

Reference numerals: 1, processor; 2, timing controller; 201, storage medium; 202, generator; 203, transmitter; 3, display panel; 301, driving chip; 302, gate driving circuit; 303, pixel circuit; S1, emission period; S2, blanking period; P, pulse; Q, interval; K, control segment; K1, repeated unit.

### DETAILED DESCRIPTION

Description will now be made in detail to illustrative embodiments, examples of which are shown in the accompanying drawings. When the following description refers to the drawings, unless otherwise indicated, same reference numerals in different drawings indicate the same or similar elements. Embodiments described in the following illustrative embodiments do not represent all embodiments consistent with the present disclosure. In contrary, they are merely examples of apparatuses consistent with some aspects of the present disclosure as described in detail in the appended claims.

The terminologies used in the present disclosure are for the purpose of describing specific embodiments only and are not intended to limit the present disclosure. Unless otherwise defined, technical terms or scientific terms used in the present disclosure shall have their ordinary meanings as understood by those of ordinary skills in the field to which the present disclosure belongs. The “first”, “second” and similar words used in the specification and claims of the present disclosure do not indicate any order, quantity or importance, but are only used to distinguish different components. Similarly, similar words such as “a” or “an” do not mean quantity limitation, but mean that there is at least one. “Multiple” or “a plurality of” means two or more. Unless otherwise specified, similar words such as “front”, “rear”, “lower” and/or “upper” are only for convenience of explanation, and are not limited to a position or a spatial orientation. Similar words such as “include” or “include” mean that the elements or objects appear before “include” or “include” cover the elements or objects listed after “include” or “include” and their equivalents, but do not exclude other elements or objects. Similar words such as “connect” or “couple” are not limited to physical or mechanical connection, but may include electrical connection, whether direct or indirect. Singular forms “a” and “the” used in the specification of the present disclosure and the appended claims are also intended to include plural forms, unless the context clearly indicates other meaning. It should also be understood that the term “and/or” as used herein refers to and includes any or all possible combinations of one or more associated listed items.

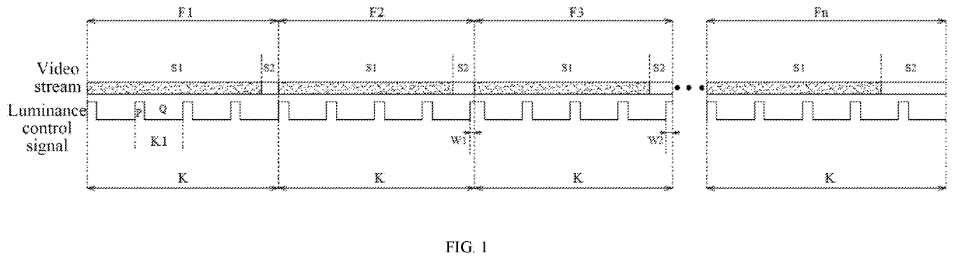

In related arts, as shown in FIG. 1, a video stream received by a timing controller includes several initial display frames (F1, F2 and F3), where each of the initial display frames includes an emission period S1 and a blanking period S2. To realize frequency conversion, from the initial display frame F1 to the initial display frame F3, the blanking period S2 in each of the initial display frames sequentially increases, so that the frame frequency decreases. Then, a luminance control signal generated by the timing controller according to the video stream is a pulse signal, where the pulse signal includes several pulses P. Duty ratios of segments of the luminance control signal corresponding to respective initial display frames have changed, which is easy to cause occurrence of flickering.

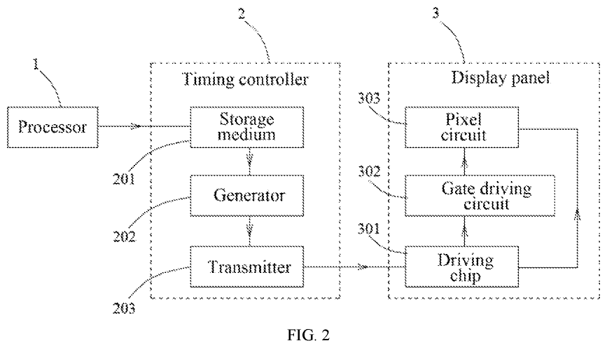

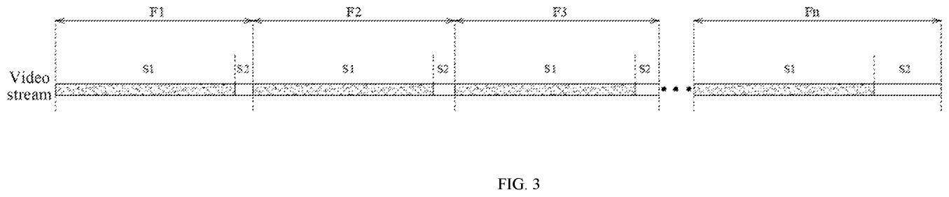

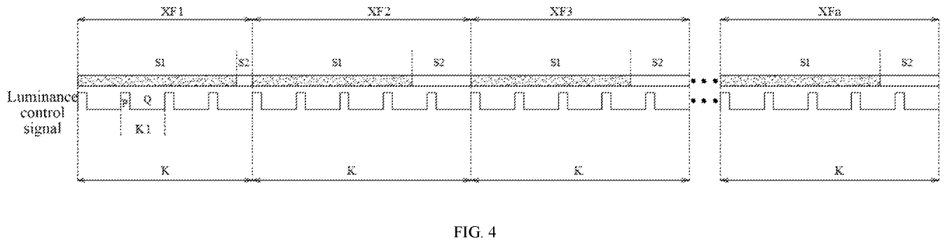

FIG. 2 is a schematic block diagram of a display apparatus. FIG. 3 is a schematic diagram of a video stream. FIG. 4 is a schematic diagram of modified display frames and a luminance control signal. An embodiment of the present disclosure provides a control method of a timing controller 2. The timing controller 2 is applied to a display apparatus. The display apparatus may further include a processor 1 and a display panel 3. The control method may include:

Step S10, receiving and storing a video stream, where the video stream includes n initial display frames (F1, F2, F3, . . . , Fn) arranged in sequence, n is greater than or equal to 2, and a frame frequency of each initial display frame sequentially increases or decreases from a first initial display frame F1 to an n-th initial display frame Fn.

Step S20, generating a luminance control signal and n modified display frames (XF1, XF2, XF3, . . . , XFn) according to the n initial display frames, where the n modified display frames respectively correspond to the n initial display frames; the luminance control signal is a pulse signal and includes n control segments K, and the n control segments K respectively correspond to the n modified display frames.

Step S30, sending the luminance control signal and the n modified display frames to a display panel 3, so that the display panel 3 displays according to the modified display frames.

According to the control method in the embodiment of the present disclosure, a luminance control signal and n modified display frames are generated according to n initial display frames, where the n modified display frames respectively correspond to the n initial display frames, the luminance control signal and the n modified display frames are sent to a display panel 3, so that the display panel 3 displays according to the modified display frames, and it is avoided that the display panel 3 displays according to the initial display frames, thereby improving display effect.

In the following, each step of the control method according to the embodiments of the present disclosure will be described in detail.

In step S10, a video stream is received and stored, where the video stream includes n initial display frames (F1, F2, F3, . . . , Fn) arranged in sequence, n is greater than or equal to 2, and a frame frequency of each initial display frame sequentially increases or decreases from a first initial display frame to an n-th initial display frame.

The video stream can be generated by the processor 1. Specifically. the display apparatus may further include a memory. The memory can store a plurality of software applications. The software applications may represent video game, virtual reality (VR) or augmented reality (AR) applications. As a part of an execution process, the processor 1 executes the software applications to generate the video frame. The processor 1 can send the video stream to the timing controller 2 through a display interface based on eDP embedded display port standard, and the timing controller 2 can receive the video stream from the processor 1 through the display interface and store the video stream.

The video stream includes n initial display frames arranged in sequence, where n is greater than or equal to 2. Each of the n initial display frames may include an emission period S1 and a blanking period S2. The blanking period S2 may be a vertical blanking (V-blanking) period. Emission periods S1 of the n initial display frames may have a same duration.

The video streams in FIG. 1 and FIG. 3 are same. In an embodiment, as shown in FIG. 1 and FIG. 3, from the first initial display frame F1 to the n-th initial display frame Fn, the frame frequency of each initial display frame sequentially decreases, and the blanking period S2 of each initial display frame sequentially increases. Specifically, as shown in FIG. 1 and FIG. 3, a frame frequency of the first initial display frame F1 is 144 Hz, a frame frequency of a second initial display frame F2 is 143 Hz, a frame frequency of a third initial display frame F3 is 142 Hz, and a frame frequency of the n-th initial display frame Fn is 115.2 Hz. The frame frequency described in the present disclosure is refresh rate. From the first initial display frame F1 to the n-th initial display frame Fn, an emission period S1 of each of the initial display frames corresponds to 2000H (pixel rows). A blanking period S2 of the first initial display frame F1 corresponds to 208H, a blanking period S2 of the second initial display frame F2 corresponds to 223H (a width W1 corresponds to 15H), a blanking period S2 of the third initial display frame F3 corresponds to 239H (a width W2 corresponds to 31H), and a blanking period of the n-th initial display frame Fn corresponds to 760H. In FIG. 1, the luminance control signal includes a plurality of repeated units K1, and each repeated unit K1 correspondingly manages 552H. Each repeated unit K1 includes a pulse P and an interval Q. In another embodiment, from the first initial display frame F1 to the n-th initial display frame Fn, the frame frequency of each initial display frame sequentially increases, and the blanking period S2 of each initial display frame sequentially decreases.

In step S20, a luminance control signal and n modified display frames (XF1, XF2, XF3, . . . , XFn) are generated according to the n initial display frames. where the n modified display frames (XF1, XF2, XF3, . . . , XFn) respectively correspond to the n initial display frames (F1, F2, F3, . . . , Fn); the luminance control signal is a pulse signal and includes n control segments K, and the n control segments K respectively correspond to the n modified display frames (XF1, XF2, XF3, . . . , XFn).

It is taken as an example that, from the first initial display frame F1 to the n-th initial display frame Fn, the frame frequency of each of the initial display frames sequentially decreases, and from a second modified display frame XF2 to an n-th modified display frame XFn, frame frequencies of the modified display frame are same, and a frame frequency of a first modified display frame XF1 is greater than a frame frequency of the second modified display frame XF2. Specifically, in FIG. 4, the frame frequency of the first modified display frame XF1 is 144 Hz, and all of the frame frequencies of the second modified display frame XF2 to the n-th modified display frame XFn are 115.2 Hz. From the first modified display frame XF1 to the n-th modified display frame XFn, an emission period S1 of each of the modified display frames corresponds to 2000H (pixel rows). A blanking period S2 of the first modified display frame XF1 corresponds to 208H, and all of blanking periods S2 of the second modified display frame XF2 to the n-th modified display frame XFn correspond to 760H.

In FIG. 4. the luminance control signal includes n control segments K. and each control segment K includes a plurality of repeated units K1, and each repeated unit K1 correspondingly manages 552H. Each repeated unit K1 includes a pulse P and an interval Q. Duty ratio of the n control segments K may be same. A duty ratio is equal to a ratio between a sum of widths of all pulses P within a control segment K and a total duration of the entire control segment K. A width of a pulse P is a duration of the single pulse P. A number of pulses P in each of the n control segments K may be an integer, for example, 4, 5 or 6, etc. At least two control segments K in the n control segments K have a same number of pulses.

In an embodiment, (n−1) control segments K corresponding to the second modified display frame XF2 to the n-th modified display frame XFn respectively have a same number of pulses P. In an example, the number of pulses P in the control segment K corresponding to the first modified display frame XF1 and the number of pulses P in the control segment K corresponding to the second correction display frame XF2 are different. From the first initial display frame F1 to the n-th initial display frame Fn, the frame frequency of each of the initial display frames sequentially decreases, a number of pulses in a control segment K corresponding to the first modified display frame XF1 is less than a number of pulses in a control segment K corresponding to the second modified display frame XF2, for example, the number of pulses in the control segment K corresponding to the first modified display frame XF1 is 4, and the number of pulses in the control segment K corresponding to the second modified display frame XF2 is 5; it is taken as an example that, from the first initial display frame F1 to the n-th initial display frame Fn, the frame frequency of each of the initial display frames sequentially increases, a number of pulses in a control segment K corresponding to the first modified display frame XF1 is greater than a number of pulses in a control segment K corresponding to the second modified display frame XF2.

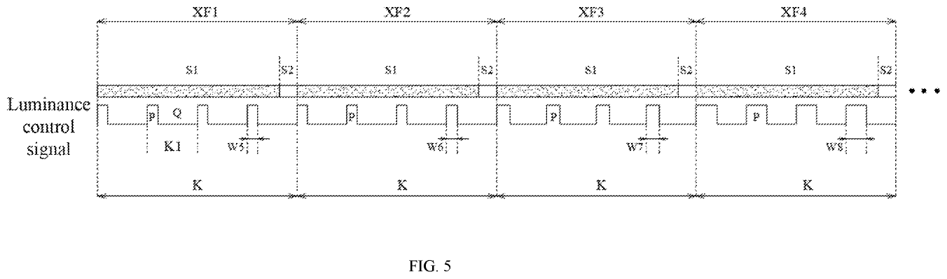

In another embodiment, from the first initial display frame F1 to the n-th initial display frame Fn, the frame frequency of each of the initial display frames sequentially decreases, and a number of pulses P in a control segment K corresponding to an m-th modified display frame is equal to a number of pulses P in a control segment K corresponding to a first modified display frame, m is greater than or equal to 3; pulses P in the control segment K corresponding to the m-th modified display frame respectively have an equal width, and the width of each pulse P in the control segment K corresponding to the m-th modified display frame is greater than a width of each pulse P in the control segment K corresponding to the first modified display frame, and a difference between the width of each pulse P in the control segment K corresponding to the m-th modified display frame and the width of each pulse P in the control segment K corresponding to the first modified display frame is a first difference C₀, and a product of the first difference C₀ and the number B₀ of pulses P in the control segment K corresponding to the first modified display frame XF1 is equal to a difference E₀ between a blanking period S2 of a (m−1)-th initial display frame and a blanking period S2 of the first initial display frame F1, that is, C₀*B₀=E₀, where “*” represents a multiplication operation. Specifically, in FIG. 5, widths of pulses P in a single control segment K are equal; a width W5 of pulses P in a control segment K corresponding to the first modified display frame XF1 is equal to a width W6 of pulses P in a control segment K corresponding to the second modified display frame XF2, that is, in FIG. 5, W5=W6; a width W7 of pulses P in a control segment K corresponding to a third modified display frame XF3 is greater than the width W6 of pulses P in the control segment K corresponding to the second modified display frame XF2, and a product of a difference between the width W7 of pulses P and the width W6 of pulses P and a number of pulses P is equal to a width W1 in FIG. 1, that is, in FIGS. 5, W7>W6, and (W7−W6)*(the number of pulses P)=W1; a width W8 of pulses P in a control segment K corresponding to a fourth modified display frame XF4 is greater than the width W7 of pulses P in the control segment K corresponding to the third modified display frame XF3, and a product of a difference between the width W8 of pulses P and the width W7 of pulses P and a number of pulses P is equal to a width W2 in FIG. 1, that is, in FIGS. 5, W8>W7, and (W8−W7)*(the number of pulses P)=W2; as can be seen, in the present embodiment of the present disclosure, an extra part caused by frame frequency change in the luminance control signal is equally allocated to respective pulses P in a next control segment K.

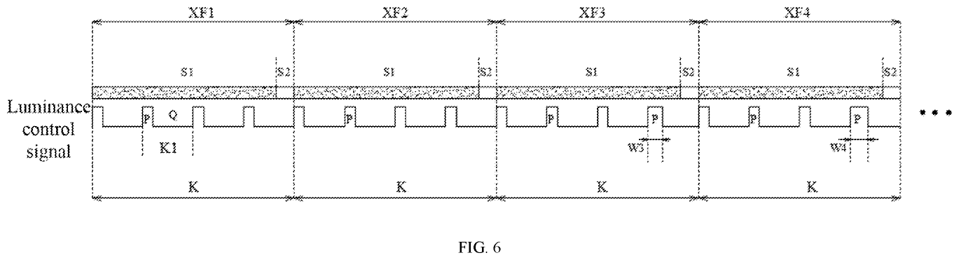

In another embodiment, from the first initial display frame F1 to the n-th initial display frame Fn, the frame frequency of each initial display frame sequentially decreases, and a number of pulses P in a control segment K corresponding to an m-th modified display frame is equal to a number of pulses P in a control segment K corresponding to a first modified display frame XF1, m is greater than or equal to 3; in pulses P of the control segment K corresponding to the m-th modified display frame, a width of a last pulse P is greater than a width of any of remaining pulses P, and a difference between the width of the last pulse P and the width of any one of the remaining pulses P is a second difference, and the second difference is equal to a difference between a blanking period S2 of a (m−1)-th initial display frame and a blanking period S2 of the first initial display frame F1. Specifically, in FIG. 6, widths of respective pulses P in the control segment K corresponding to the first modified display frame XF1 are equal, widths of respective pulses P in the control segment K corresponding to the second modified display frame XF2 are equal, a width of each pulse P in the control segment K corresponding to the first modified display frame XF1 is equal to a width of each pulse P in the control segment K corresponding to the second modified display frame XF2; in a control segment K corresponding to a third modified display frame XF3, except for a last pulse P, a width of each of the remaining pulses P is equal to the width of each pulse in the control segment K corresponding to the second modified display frame XF2; in the control segment K corresponding to the third modified display frame XF3, a width W3 of the last pulse P is greater than a width of each of the remaining pulses P, and a difference thereof may be equal to the width W1 in FIG. 1; in a control segment K corresponding to a fourth modified display frame XF4, except for a last pulse P, a width of each of the remaining pulses P is equal to the width of each pulse in the control segment K corresponding to the second modified display frame XF2; in the control segment K corresponding to the fourth modified display frame XF4, a width W4 of the last pulse P is greater than a width of each of the remaining pulses P, and a difference thereof may be equal to the width W2 in FIG. 1; as can be seen, in the present embodiment of the present disclosure, an extra part caused by frame frequency change in the luminance control signal is allocated to a last pulse P in a next control segment K.

In step S30, the luminance control signal and the n modified display frames are sent to a display panel 3, so that the display panel 3 displays according to the modified display frames.

The display panel 3 of the embodiments of the present disclosure may include a driving chip 301 (Source IC), a pixel circuit 303 and a gate driving circuit 302. The pixel circuit 303 may be located within a display area, and is configured to drive emission elements of the display panel 3 to display. The gate driving circuit 302 may be connected to the pixel circuit 303, and is configured to send a scanning signal and the luminance control signal to the pixel circuit 303. The pixel circuit 303 and the gate driving circuit 302 are both connected to the driving chip 301. The timing controller 2 is configured to send the luminance control signal and the n modified display frames to the driving chip 301. The driving chip 301 send a control signal to the gate driving circuit 302 according to the luminance control signal, so that the gate driving circuit 302 sends the scanning signal and the luminance control signal to the pixel circuit 303. The driving chip 301 is configured to send the n modified display frames to the pixel circuit 303. The display panel 3 is configured to display according to the modified display frames. Luminance of the display panel 3 can be controlled through duty ratios of the control segments K corresponding to the modified display frames. When duty ratios are same, the luminance can be same. Since the duty ratios of the n control segments K can be same, luminance of the display panel 3 can be same, so as to avoid flickering.

An embodiment of the present disclosure can further provide a timing controller 2. The timing controller 2 can include a storage medium 201, a generator 202 and a transmitter 203.

The storage medium 201 is configured to receive and store a video stream, where the video stream includes n initial display frames arranged in sequence, n is greater than or equal to 2, and a frame frequency of each initial display frame sequentially increases or decreases from a first initial display frame to an n-th initial display frame. The storage medium 201 is configured to perform the above-described step S10.

The generator 202 is configured to generate a luminance control signal and n modified display frames according to the n initial display frames, where the n modified display frames respectively correspond to the n initial display frames; the luminance control signal is a pulse signal and includes n control segments K, and the n control segments K respectively correspond to the n modified display frames. The generator 202 is configured to perform the above-described step S20.

The transmitter 203 is configured to send the luminance control signal and the n modified display frames to a display panel 3, so that the display panel 3 displays according to the modified display frames. The transmitter 203 is configured to perform the above-described step S30.

An embodiment of the present disclosure further provides a display apparatus. The display apparatus may include the above-described processor 1, the above-described display panel 3, and the timing controller 2 of any of the above embodiments.

The display apparatus, the timing controller and the control method thereof provided by the embodiments of the present disclosure belong to a same inventive concept, description of related details and advantageous effects can be referred to from each other, which will not be repeated here.

The above are only preferred embodiments of the present disclosure, and they do not limit the present disclosure in any form. Although the present disclosure has been disclosed in the preferred embodiments, they are not used to limit the present disclosure. Any person familiar with this profession can make some changes or modify it into an equivalent embodiment by using the technical content disclosed above without departing from the scope of the technical solution of the present disclosure. So long as the content does not depart from the technical solution of the present disclosure, any simple modifications, equivalent changes or modifications made to the above embodiments according to the technical essence of the present disclosure belong to the scope of the technical solution of the present disclosure.

1. A control method of a timing controller, comprising:
receiving and storing a video stream, wherein the video stream comprises n initial display frames arranged in sequence, n is greater than or equal to 2, and a frame frequency of each initial display frame sequentially increases or decreases from a first initial display frame to an n-th initial display frame;
generating a luminance control signal and n modified display frames according to the n initial display frames, wherein the n modified display frames respectively correspond to the n initial display frames; the luminance control signal is a pulse signal and comprises n control segments, and the n control segments respectively correspond to the n modified display frames; and
sending the luminance control signal and the n modified display frames to a display panel, so that the display panel displays according to the n modified display frames.

2. The control method according to claim 1, wherein duty ratios of the n control segments are same.

3. The control method according to claim 1, wherein a number of pulses in each of the n control segments is an integer.

4. The control method according to claim 3, wherein at least two of the n control segments have a same number of pulses.

5. The control method according to claim 4, wherein (n−1) control segments respectively corresponding to a second modified display frame to an n-th modified display frame have a same number of pulses.

6. The control method according to claim 3, wherein control segments respectively corresponding to a first modified display frame and a second modified display frame have different numbers of pulses.

7. The control method according to claim 6, wherein the frame frequency of each initial display frame sequentially decreases, and a number of pulses in a control segment corresponding to the first modified display frame is less than a number of pulses in a control segment corresponding to the second modified display frame; or
the frame frequency of each initial display frame sequentially increases, and a number of pulses in a control segment corresponding to the first modified display frame is greater than a number of pulses in a control segment corresponding to the second modified display frame.

8. The control method according to claim 1, wherein each initial display frame comprises an emission period and a blanking period, and emission periods of the n initial display frames have a same duration.

9. The control method according to claim 8, wherein from the first initial display frame to the n-th initial display frame, the frame frequency of each initial display frame sequentially increases, and the blanking period of each initial display frame sequentially decreases; or
from the first initial display frame to the n-th initial display frame, the frame frequency of each initial display frame sequentially decreases, and the blanking period of each initial display frame sequentially increases.

10. The control method according to claim 8, wherein from the first initial display frame to the n-th initial display frame, the frame frequency of each initial display frame sequentially decreases, and a number of pulses in a control segment corresponding to an m-th modified display frame is equal to a number of pulses in a control segment corresponding to a first modified display frame, m is greater than or equal to 3; pulses in the control segment corresponding to the m-th modified display frame have an equal width, and the width of each pulse in the control segment corresponding to the m-th modified display frame is greater than a width of each pulse in the control segment corresponding to the first modified display frame, and a difference between the width of each pulse in the control segment corresponding to the m-th modified display frame and the width of each pulse in the control segment corresponding to the first modified display frame is a first difference, and a product of the first difference and the number of pulses in the control segment corresponding to the first modified display frame is equal to a difference between a blanking period of a (m−1)-th initial display frame and a blanking period of the first initial display frame.

11. The control method according to claim 8, wherein from the first initial display frame to the n-th initial display frame, the frame frequency of each initial display frame sequentially decreases, and a number of pulses in a control segment corresponding to an m-th modified display frame is equal to a number of pulses in a control segment corresponding to a first modified display frame, m is greater than or equal to 3; in pulses of the control segment corresponding to the m-th modified display frame, a width of a last pulse is greater than a width of any one of remaining pulses, and a difference between the width of the last pulse and the width of any one of the remaining pulses is a second difference, and the second difference is equal to a difference between a blanking period of a (m−1)-th initial display frame and a blanking period of the first initial display frame.

12. A timing controller, comprising:
a storage medium, configured to receive and store a video stream, wherein the video stream comprises n initial display frames arranged in sequence, n is greater than or equal to 2, and a frame frequency of each initial display frame sequentially increases or decreases from a first initial display frame to an n-th initial display frame;
a generator, configured to generate a luminance control signal and n modified display frames according to the n initial display frames, wherein the n modified display frames respectively correspond to the n initial display frames; the luminance control signal is a pulse signal and comprises n control segments, and the n control segments respectively correspond to the n modified display frames; and
a transmitter, configured to send the luminance control signal and the n modified display frames to a display panel, so that the display panel displays according to the n modified display frames.

13. The timing controller according to claim 12, wherein duty ratios of the n control segments are same.

14. The timing controller according to claim 12, wherein a number of pulses in each of the n control segments is an integer.

15. The timing controller according to claim 14, wherein at least two of the n control segments have a same number of pulses.

16. (canceled)

17. The timing controller according to claim 14, wherein control segments respectively corresponding to a first modified display frame and a second modified display frame have different numbers of pulses.

18. The timing controller according to claim 17, wherein the frame frequency of each initial display frame sequentially decreases, and a number of pulses in a control segment corresponding to the first modified display frame is less than a number of pulses in a control segment corresponding to the second modified display frame; or
the frame frequency of each initial display frame sequentially increases, and a number of pulses in a control segment corresponding to the first modified display frame is greater than a number of pulses in a control segment corresponding to the second modified display frame.

19. The timing controller according to claim 12, wherein each initial display frame comprises an emission period and a blanking period, and emission periods of the n initial display frames have a same duration.

20. The timing controller according to claim 19, wherein from the first initial display frame to the n-th initial display frame, the frame frequency of each initial display frame sequentially increases, and the blanking period of each initial display frame sequentially decreases; or
from the first initial display frame to the n-th initial display frame, the frame frequency of each initial display frame sequentially decreases, and the blanking period of each initial display frame sequentially increases.

21. A display apparatus, comprising a processor, a display panel, and the timing controller according to claim 12, wherein the processor is configured to send the video stream to the timing controller, and the display panel is configured to receive the luminance control signal and the n modified display frames sent by the timing controller.
